(19) United States
(12) Patent Application Publication
(10) Pub. No.: US 2019/0126252 A1
(43) Pub. Date: May 2, 2019

(54) CATALYST MATERIALS, SYSTEMS, AND METHODS OF MAKING

(71) Applicant: BATTELLE MEMORIAL INSTITUTE, Richland, WA (US)

(72) Inventors: Lei Nie, Richland, WA (US); Yong Wang, Richland, WA (US)

(73) Assignee: BATTELLE MEMORIAL INSTITUTE, Richland, WA (US)

(21) Appl. No.: 16/166,855

(22) Filed: Oct. 22, 2018

Related U.S. Application Data
(60) Provisional application No. 62/717,526, filed on Aug. 10, 2018.
(60) Provisional application No. 62/579,959, filed on Nov. 1, 2017.

(51) Int. Cl. B01J 23/63; B01J 37/10; B01J 37/02; B01J 35/10; F01N 3/10

(52) U.S. Cl. CPC B01J 23/63; B01J 37/10; B01J 37/0207; F01N 3/103; B01J 35/1014; B01J 35/1038; B01J 37/0209

(57) ABSTRACT

Disclosed herein are catalyst materials and vehicle catalytic converters having platinum atomically dispersed on a ceria support and having a T₉₀ value less than or equal to 150° C., wherein the T₉₀ value represents the temperature required for 90% CO conversion. Also disclosed are methods of making the catalyst material involving hydrothermally treating at a temperature of at least 700° C. a Pt/ceria material comprising atomically dispersed Pt on a ceria support and activating 90% CO conversion at a temperature less than or equal to 150° C. (i.e., T₉₀≤150° C.).

### CROSS-REFERENCE TO RELATED APPLICATIONS

This invention claims priority from U.S. provisional patent application No. 62/579,959, entitled CATALYST MATERIALS, SYSTEMS, AND METHODS OF MAKING, filed Nov. 1, 2017 and from U.S. provisional patent application No. 62/717,526, entitled CATALYSTS HAVING LOW-TEMPERATURE ACTIVITY AND METHODS OF MAKING THE SAME, filed Aug. 10, 2018.

### ACKNOWLEDGEMENT OF GOVERNMENT SUPPORT

This invention was made with Government support under Contract DE-AC0576RL01830 awarded by the U.S. Department of Energy. The Government has certain rights in the invention.

### FIELD

The present disclosure relates generally to catalyst materials, systems, and methods of making same, and relates more particularly to those including platinum on ceria for low-temperature CO oxidation.

### BACKGROUND

Platinum and ceria are two important components in catalysis. For example, they have been two principal components of catalytic converters in vehicles. The material needs to be stable even under harsh conditions such as high temperatures, and/or oxidative/reductive atmosphere. At the same time, many future applications will require these catalysts to be active at low-temperatures. In one example, advanced combustion engines are being developed to meet higher standards of fuel efficiency and lowered greenhouse gas emissions. But their commercial potential is contingent on meeting emission standards for the control of criteria pollutants (including CO, NOx, hydrocarbons, and particulate matter), which affect air quality. The exhaust temperature of advanced engines is significantly lower, especially during the cold-start, requiring catalysts to become active at temperatures below 150° C. to meet future emission regulations. Single atom heterogeneous catalysts have demonstrated excellent low temperature reactivity but do not meet the demands of high-temperature thermal/hydrothermal durability that is needed during operations under high engine loads and periodic regeneration of catalytic soot filters. Accordingly, a need exists for CO-oxidation catalyst materials, systems, and methods of making same that are active at low temperatures and stable at high temperatures.

### SUMMARY

Disclosed are catalyst materials, systems, and methods of making same. Embodiments encompass atomically dispersed platinum on a ceria support and can function at low temperatures for CO oxidation. In one embodiment, a catalyst material comprises platinum atomically dispersed on an activated ceria support and has a T₉₀ value less than or equal to 150° C. The T₉₀ value represents the temperature required for 90% CO conversion. In certain embodiments, the activated ceria support comprises activated surface lattice oxygen sites. In certain embodiments, the activated surface lattice oxygen sites are proximal to the atomically dispersed platinum. In certain embodiments, the activated surface lattice oxygen sites are stable up to 800° C. in an oxidizing environment. In certain embodiments, the catalyst material exhibits a second reduction peak at temperature lower than a first reduction peak attributed to a Pt—O—Ce bond in a hydrogen temperature programmed reduction profile. Absent the hydrothermal processing described herein, the catalyst material will exhibit the first reduction peak, but not the second. For example, a catalyst material that is calcined at high temperatures (for example 800° C.) in an oxidizing environment, but not subsequently steam treated will not exhibit both the first and second reduction peaks in a H₂ TPR analysis. The particular temperature position of the first and second peaks can vary depending on experiment conditions. In certain embodiments, the temperature position of the second reduction peak occurs within a range of 75° C. lower than the position of the first reduction peak in a H₂ TPR profile. In other embodiments, the temperature position of the second reduction peak occurs within a range of 50, 40, 30, 20, or 15° C. lower than the position of the first reduction peak in a H₂ TPR profile. In certain embodiments, the catalyst material has no observable aggregates of platinum at the surface region of the catalyst material. In certain embodiments, the catalyst material is capable of maintaining 95% CO conversion for at least 300 hours at 145° C. for an exhaust stream having a gas hourly space velocity of 200,000 ml per gram of the catalyst material and a CO/O₂ molar ratio of 1/25. In certain embodiments, the atomically dispersed platinum is covalently bonded to the activated ceria support. In certain embodiments, the catalyst material further comprises Pt²⁺ atomically dispersed on the activated ceria support.

In some embodiments, a method of synthesizing a CO conversion catalyst having low-T activity comprises hydrothermally treating at a temperature of at least 700° C. a Pt/ceria material comprising atomically dispersed Pt on a ceria support and activating 90% CO conversion at a temperature less than or equal to 150° C. (i.e., T₉₀≤150° C.). In certain embodiments, the method further comprises forming active surface lattice oxygen sites on the ceria support. In certain embodiments, the active surface lattice oxygen sites are in the vicinity of Pt atoms. In certain embodiments, the method further comprises calcining in an oxidizing environment the Pt/ceria material at a temperature greater than or equal to 650° C. prior to said hydrothermally treating step. In certain embodiments, said calcining occurs at a temperature greater than or equal to 800° C. In certain embodiments, the Pt/ceria material comprises a non-zero amount of Pt that is less than or equal to 3 wt %. In certain embodiments, said hydrothermally treating comprises heating the Pt/ceria material in an environment having a non-zero amount of water less than 100 vol %, 75 vol %, 50 vol %, or 25 vol %. In certain embodiments, the non-zero amount of water is less than 15%. In certain embodiments, the method further comprises maintaining atomic dispersion of the Pt on the ceria support.

In some embodiments, a vehicle catalytic converter comprises a catalyst material on a monolith, the catalyst material comprising platinum atomically dispersed on an activated ceria support and having a T₉₀ value less than or equal to 150° C., wherein the T₉₀ value represents the temperature required for 90% CO conversion. In certain embodiments, the activated ceria support comprises activated surface lattice oxygen sites proximal to the atomically dispersed platinum.

The purpose of the foregoing summary and the latter abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. Neither the summary nor the abstract is intended to define the invention of the application, which is measured by the claims, nor is it intended to be limiting as to the scope of the claims in any way.

### BRIEF DESCRIPTION OF THE DRAWINGS

FIG. 1 is a flowchart summarizing an embodiment of a method for synthesizing catalyst materials described herein.

FIGS. 2A-2D are characterization results of Pt/CeO₂ materials including representative AC-STEM images of (2A) Pt/CeO₂; (2B) Pt/CeO₂_{_}S; Single atoms of platinum were circled in the images. (2C) and (2D) show catalytic CO oxidation light-off performance of Pt/CeO₂ and Pt/CeO₂_{_}S catalysts. [O₂]=10%, [CO]=0.4% balanced with Argon at GHSV: 200,000 ml/(g_{cat}·hr). Temperature ramp: 2° C./min. Pressure: 1 atm.

FIGS. 3A-3D characterize Pt single atoms (Pt2+) and active surface lattice oxygen Pt/CeO₂ materials according to CO adsorption DRIFTS for (3A) Pt/CeO₂; (3B) Pt/CeO₂_{_}S. After 30 min of CO oxidation (black lines), the CO flow was discontinued and spectra kept being recorded for 15 min with continuing O₂ flow (magenta lines). Temperature: 180° C. (3C) Time-resolved CO oxidation with surface active lattice oxygen of Pt/CeO₂ catalysts at 300° C. Conditions: 50 sccm He from 0 to 50 s; 50 sccm 10% CO/He from 50 s to 200 s. (3D) H₂-temperature programmed reduction (TPR) profiles of Pt/CeO₂ catalysts.

FIGS. 4A and 4B include diagrams and charts depicting steam treatment effects on a Pt₁/CeO2 catalyst. (4A) V_{O}: oxygen vacancy. The active site created by the steam treatment which is responsible for low-temperature CO oxidation activity is highlighted by dashed-line circles; (4B) Gibbs free energy of dissociative water adsorption on Pt₁—CeO₂ surface. One oxygen vacancy was filled by water under steam treatment condition (p(H₂O)=0.1 atm).

FIG. 5 is a diagram depicting one possible reaction mechanism for CO oxidation on an embodiment of catalyst materials described herein. The inset shows the calculated energy profiles in kJ/mol. The structures of intermediates and transition states (TS) of the key elementary steps are shown in the reaction cycle. The reaction cycle corresponds to the upper line in the graph.

### DETAILED DESCRIPTION

Disclosed herein are catalyst materials comprising platinum atomically dispersed on a ceria support and having a T₉₀ value less than or equal to 150° C., wherein the T₉₀ value represents the temperature required for 90% CO conversion. Also disclosed are methods of making the catalyst material and vehicle catalytic converters comprising the material.

Zero valent atoms of platinum group metals can be mobile at high temperatures and can agglomerate into larger particles, losing their catalytic efficiency. To keep them stable under working conditions, atoms can be anchored to the support, forming covalent bonds with oxygen atoms in the catalyst support. But achieving high catalytic activity with anchored metal ions remains a formidable challenge. Platinum has been stabilized over ceria via calcination and aging at high temperature in oxidative atmosphere. However, once platinum is anchored to the support, the low-temperature activity is eliminated. The inventors have determined that in a catalyst having atomically dispersed platinum supported on ceria, low temperature activity can be achieved even while the catalyst is able to survive harsh conditions encountered in operating situations.

In some embodiments, the catalyst material comprises atomically dispersed platinum on ceria, which is active and thermally stable. The platinum can comprise Pt²⁺. Activation can occur via hydrothermal treatment to simultaneously achieve the low-temperature CO oxidation activity while providing outstanding hydrothermal stability. According to certain embodiments, a new type of active site is created on ceria in the vicinity of the atomically dispersed platinum. In certain embodiments, the active sites are proximal to the Pt atoms. The active sites can neighbor the Pt atoms, but are not necessarily nearest neighbors to a Pt atom. The active sites, in some embodiments are at a distance within which bond formation can occur. In a particular example, an active site is within 5 angstroms of a Pt atom. In other examples, an active site is within 4, 3, 2.5, or 2 angstroms of a Pt atom. The active sites can comprise activated surface lattice oxygen sites, which can be expressed in one way as activated O_{lattice}[H] sites. The active sites can be stable up to 800° C., even in oxidizing environments.

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” or “approximately” is recited.

To further illustrate certain embodiments of the disclosed catalyst materials and systems, and the disclosed methods of making the same, and to provide various comparative analyses and data, below are some examples with comparison test data.

The activity of ceria-supported catalysts can be improved by treating the catalyst in a reducing atmosphere, such as in H₂ gas. However, such a reducing treatment typically causes the formation of Pt nanoparticles, which are subject to deactivation under oxidizing atmospheres. Unexpectedly, the inventors have discovered that hydrothermal aging at high temperature can activate catalyst materials comprising atomically dispersed Pt on a support comprising CeO₂, leading to significantly improved low temperature CO oxidation without any observable change in the atomic dispersion of Pt. Although steam treatment is widely used to improve catalytic stability of zeolites, it is not applied to supported precious metal catalysts due to the fact that sintering of the metal particles and degradation of metal oxide supports can take place, leading to reduced catalyst activity. Contrary to conventional practice, embodiments described herein utilize steam treatment for the formation of active surface lattice oxygen in the vicinity of atomically dispersed Pt, resulting in catalyst exhibiting dramatically enhanced performance.

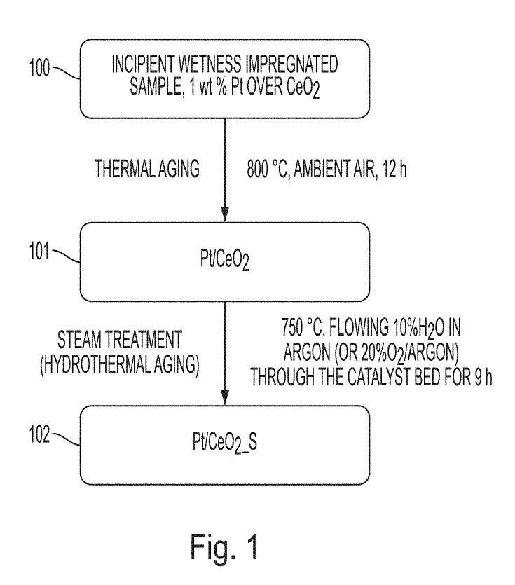

In the following examples, thermally aged and subsequently steam treated (hydrothermally aged) catalysts are designated as Pt/CeO₂ and Pt/CeO₂_{_}S, respectively. Catalyst preparation details, according to one embodiment, are summarized in FIG. 1. In one example of the process summarized in FIG. 1, Ce(NO₃)₃.6H₂O was heated in air at 350° C. for 2 h to obtain CeO₂ polyhedra (68 m²/g). A Pt/CeO₂ catalyst (1 wt. % Pt, nominal) was prepared by incipient wetness impregnation (IWI) 100. Briefly, an appropriate amount of chloroplatinic acid (8 wt. %) was added drop-wise to the CeO₂ while grinding. The resultant powder was then dried at 80° C. for 12 h. Afterwards the sample was directly calcined and thermally aged at 800° C. for 12 h in flowing air. The formed sample is designated as Pt/CeO₂ 101. The Pt/CeO₂ sample was loaded as a packed bed in ¼″ OD quartz tube flow reactor and steam treated by 10 vol % H₂O in Argon (or in 20% O₂/Argon) at 750° C. for 9 h, typically with a space velocity of 10,000 mL/(g_{cat}·h). The sample was then cooled down to 300° C. and the water vapor was discontinued. Afterwards, the sample was purged in the same carrier gas for 1 h before cooling down to room temperature. The resulting sample is designated as Pt/CeO₂_{_}S 102.

Two additional commercial ceria were used as the catalyst supports for comparison, i.e., CeO₂ (Aldrich #544841, 34 m²/g) and CeO₂ (Rhodia, high surface area 120 m²/g). Catalysts with 1 wt. % Pt loading were prepared and pretreated using the identical procedure as described above for Pt/CeO₂ and Pt/CeO₂_{_}S. Similarly, catalysts without steam treatment are designated as Pt/CeO₂(Aldrich) and Pt/CeO₂(HSA, Rhodia) while Pt/CeO₂_{_}S (Aldrich) Pt/CeO₂_{_}S(HSA, Rhodia) are the samples after steam treatment.

Mixed oxide catalyst CuCoCeOx was prepared according to literature. Copper nitrate trihydrate (Cu(NO₃)₂.3H₂O, Aldrich), cobalt chloride hexahydrate (CoCl₂.6H₂O, Aldrich) and cerium nitrate hexahydrate (Ce(NO₃)₂.6H₂O, Aldrich) at molar ratio of 1:5:5 were simultaneously dissolved in deionized water at room temperature. Under stirring, NaOH solution was added dropwise. The obtained sample was washed with H₂O followed by ethanol and then dried. Finally, the sample was calcined at 600° C. for 4 h. The temperature was raised at a rate of 1° C. min⁻¹. The final product has a BET surface area of 77 m² g⁻¹.

0.5 wt % Pd/La-Al₂O₃ catalyst was prepared according to literature. La-alumina support from W. R. Grace (MI-386), containing 4 wt % La₂O₃, was used and has a BET surface area of 176 m² g⁻¹. Samples were prepared by incipient wetness impregnation (IWI) with a solution of palladium amine nitrate as precursor. After impregnation, the sample was dried at 110° C. and calcined at 700° C. for 1 h. The temperature was raised at a rate of 2° C. min⁻¹.

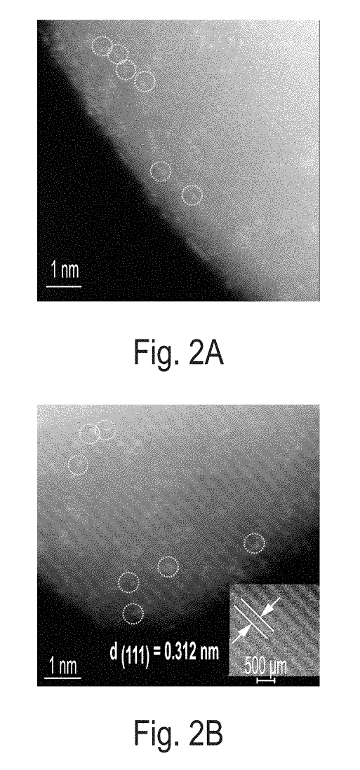

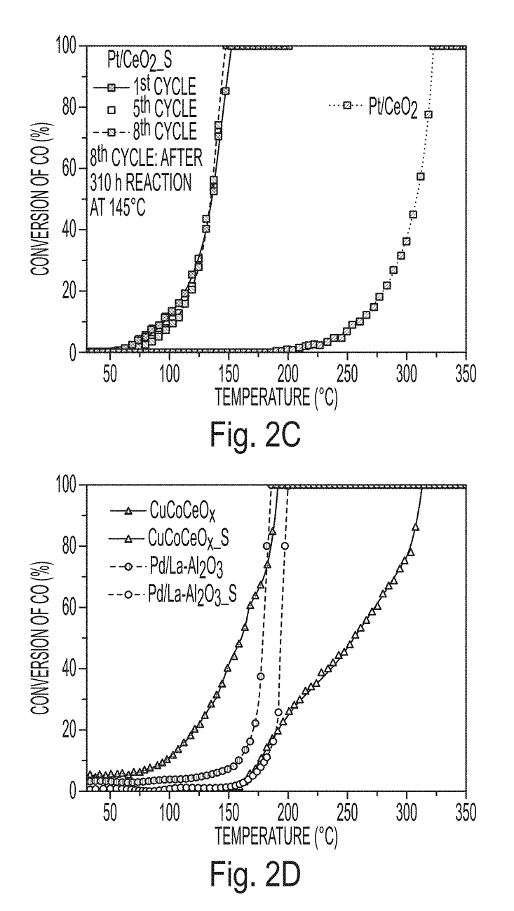

In the Pt/CeO₂ catalyst (FIG. 2A), Pt is atomically dispersed. In the Pt/CeO₂_{_}S sample, no sintering of Pt occurs and Pt remains atomically dispersed (FIG. 2B) even after harsh steam treatment at the high temperature of 750° C. The presence of Pt nanoparticles, if any, should be readily visible by STEM. No such nanoparticles were found in Pt/CeO₂ or Pt/CeO₂_{_}S even by higher resolution STEM. No diffraction peaks of Pt are observed in XRD patterns for both Pt/CeO₂ and Pt/CeO₂_{_}S samples, further confirming the high dispersion of Pt. The XANES spectra show that the Pt remains oxidized on both Pt/CeO₂ and Pt/CeO₂_{_}S samples and there are no detectable Pt—Pt first or second shell interactions in the EXAFS results verifying the atomic dispersion of Pt. Moreover, the surface areas and pore volumes for Pt/CeO₂ and Pt/CeO₂_{_}S are comparable to each other (Table 1), suggesting stable textural properties after high temperature steam treatment. Additionally, Pt stays in ionic form Pt²⁺ over both catalysts, evidenced by XPS.

TABLE 1
Characterization of the catalysts.

| | | | | | Average |
|---|---|---|---|---|---|
| | Pt | | Surface | Pore | Pore |
| | Dispersion | Pt particle size | area | volume | size |
| | (%) | (nm) | (m²/g) | (cm³/g) | (nm) |
| CeO₂ | — | — | 68 | 0.22 | 9 |
| CeO_{2—}S | — | — | 14.6 | 0.09 | 10 |
| Pt/CeO₂ | 100 | atomic dispersed | 24.6 | 0.20 | 25 |
| Pt/CeO_{2—}S | 100 | atomic dispersed | 25.6 | 0.20 | 25 |

It is generally accepted that the CO oxidation over Pt/CeO₂ follows a Mars-van Krevelen reaction mechanism. Adsorbed CO on Pt reacts with active lattice oxygen species provided by CeO₂, where no competitive adsorption between CO and O₂ is involved. The reaction rates do not depend on the partial pressure of both CO and O₂, i.e. 0th order. The reaction mechanism and kinetics are valid over a wide range of reactant compositions (lean, stoichiometric and rich conditions).

To mimic lean-burn diesel engine exhaust, we used excess O₂ in the reactant (CO/O₂=1/25 in molar ratio). The CO oxidation light-off curves were measured to evaluate catalyst performance. A space velocity of 200,000 mL/(g_{cat}·h) was used to match standard vehicle exhaust conditions. As shown in FIG. 2C, Pt/CeO₂ showed a high onset temperature of ˜210° C. After steam treatment (hydrothermal aging) at 750° C., the Pt/CeO₂_{_}S exhibited dramatically improved low-temperature reactivity compared to Pt/CeO₂ as the onset temperature was lowered to ˜60° C. Two (temperature required to reach 100% conversion) decreased from 320° C. (Pt/CeO₂) to 148° C. (Pt/CeO₂_{_}S).

TABLE 2
Low-temperature CO oxidation light-off performance comparison

| | | | | | |
|---|---|---|---|---|---|
| | T₅₀ | T₁₀₀ | Space Velocity | | |
| Catalyst | (° C.) | (° C.) | (mL/(gcat · hr)) | CO | O₂ |

Supported PGM Catalyst

| | | | | | |
|---|---|---|---|---|---|
| 1%Pt/CeO_{2—}S | 140 | 148 | 200,000 | 0.4% | 10.0% |
| 1%Pd/ZrO₂—SiO₂ | 175 | 205 | 150,000 | 0.4% | 10.0% |
| Diesel Oxidation Catalyst | 200 | 240 | 150,000 | 0.4% | 10.0% |
| 0.5%Pd/La—Al₂O₃ | 110 | 175 | 42,900 | 1.0% | 1.2% |

Mixed Oxides/Oxides

| | | | | | |
|---|---|---|---|---|---|
| CuCoCeOx | 150 | 220 | 150,000 | 0.4% | 10.0% |

Perovskite

| | | | | | |
|---|---|---|---|---|---|
| LaMnO₃—SD | 83 | 130 | 120,000 | 0.2% | 10.0% |

| | | | |
|---|---|---|---|
| LaFe_{0.95}Pd_{0.05}O₃ | 335 | 110,000 | A/F = 13~16 |

Compared to other promising catalysts in the literature that have potential commercial viability, as well as current commercial catalysts tested under similar conditions and have been subjected to 800° C. treatment in air, Pt/CeO₂_{_}S is among the most active CO oxidation catalysts (Table 2). Since the Pt/CeO₂_{_}S catalyst has been pretreated under harsh hydrothermal conditions at 750° C., it is not surprising that it also exhibits stable reactivity. There is no noticeable deactivation during 310 h time-on-stream testing with 8 light-off cycles, while 95% conversion of CO is maintained at 145° C. for 310 h. The excellent catalytic performance of Pt/CeO₂_{_}S demonstrates its potential to meet the “The 150° C. Challenge” of the U.S. Department of Energy. For comparison, we also tested CoCuCeOx and 0.5% Pd/La-Al₂O₃ which are two other promising catalysts (Table. S2). After hydrothermal aging under the same conditions as the Pt/CeO₂_{_}S catalyst, their Two increased to 350° C. and 190° C., respectively (FIG. 2D). To further investigate the durability of Pt/CeO₂_{_}S especially at high temperatures, which is crucial for operations under high engine loads, light-off performance at temperatures up to 500° C. and 800° C. were tested. No evident deactivation was found at 500° C. and slight deactivation was observed at 800° C. after one cycle, but stable performance was maintained thereafter. Furthermore, there is no detrimental effect on CO oxidation by other pollutants like hydrocarbons and NOₓ in the feed when the CO oxidation performance of Pt/CeO₂_{_}S was evaluated under simulated exhaust conditions. In addition, co-feeding water can further enhance the low-temperature CO oxidation activity over Pt/CeO₂_{_}S.

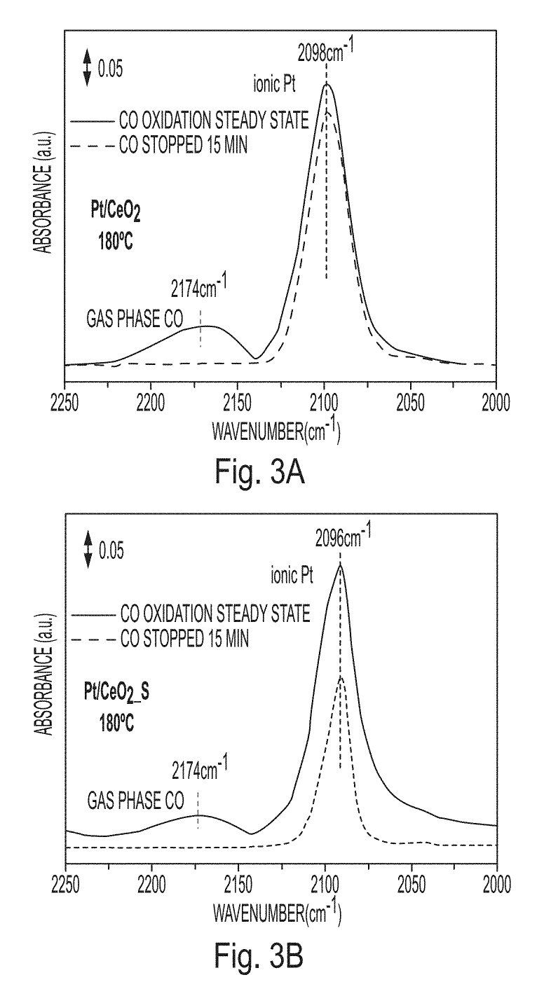

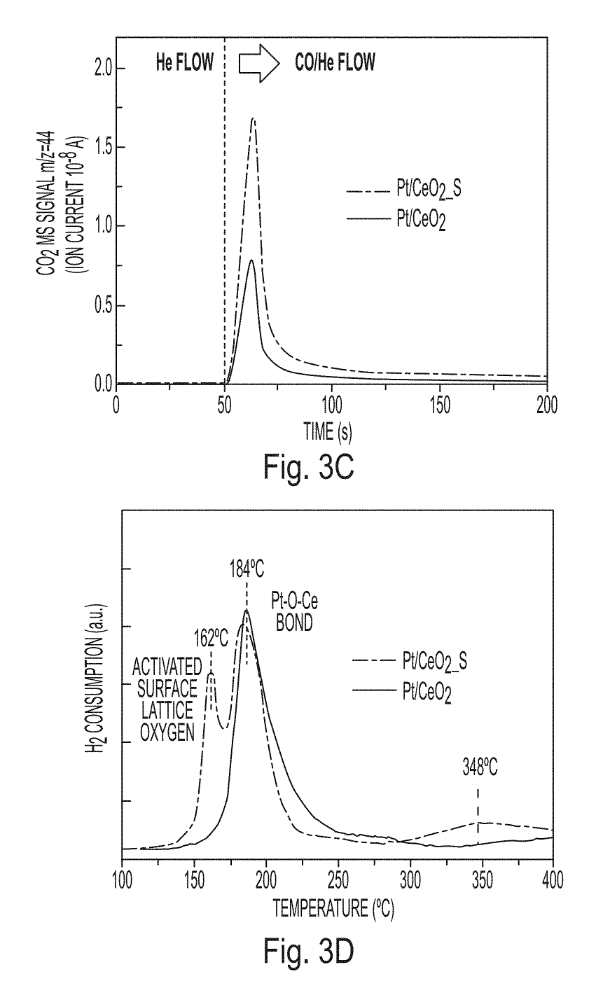

To provide mechanistic insights into the enhanced low-temperature CO oxidation reactivity of Pt/CeO₂ by steam treatment, adsorption of CO over Pt sites was studied by Diffuse Reflectance Infrared Fourier Transform Spectroscopy (DRIFTS) for both Pt/CeO₂ and Pt/CeO₂_{_}S catalysts. Under CO oxidation reaction conditions at 180° C. (CO oxidation steady state in FIGS. 3A and 3B), only ionic Pt²⁺ is present as evidenced by the bands at 2096 cm⁻¹ and 2098 cm⁻¹ which are assigned to linearly adsorbed CO on isolated ionic Pt²⁺. Combining the results from STEM (FIGS. 2A and 2B), XPS, DRIFTS and EXAFS, it can be concluded again that atomic dispersion of Pt²⁺ is maintained on both Pt/CeO₂_{_}S and Pt/CeO₂ and steam treatment does not affect the dispersion or valence (Pt²⁺) of platinum.

Over Pt/CeO₂, the IR band (2098 cm⁻¹) does not change much after CO flow was stopped at 180° C. while O₂ continued to flow (FIG. 3A). This suggests that CO adsorption on the ionic Pt site is very strong at 180° C., and it is consistent with the fact that Pt/CeO₂ did not show activity until 210° C. (FIG. 2C). However, over Pt/CeO₂_{_}S, after CO flow was discontinued for 15 min at 180° C. (with continuing O₂ flow), the intensity of IR band at 2096 cm⁻¹ decreased significantly (FIG. 3B), suggesting that the CO adsorbed on single ion Pt²⁺ was readily oxidized to CO₂. This observation agrees well with the low-temperature CO oxidation reactivity shown in FIG. 2C, i.e., Pt/CeO₂_{_}S became active at 60° C. and 100% conversion was achieved at 148° C. It can be concluded that CO adsorbed on Pt²⁺ in Pt/CeO₂_{_}S sample is more reactive than that on the Pt/CeO₂ sample. Since platinum on both samples Pt/CeO₂_{_}S and Pt/CeO₂ show the same dispersion (atomically dispersed) and valence (Pt²⁺), the difference in low-temperature reactivity between Pt/CeO₂_{_}S and Pt/CeO₂ could be attributed to neighboring lattice oxygen which is part of the active sites thus should have dramatic effect on the reactivity of the ionic Pt sites.

Active lattice oxygen sites, usually associated with the oxygen vacancies on the uppermost ceria layers in vicinity of Pt sites, are considered to be part of the active sites for this reaction. But they are short-lived and are difficult to be observed under steady-state reaction conditions. This is because the re-oxidation rate of oxygen vacancies is at least one order of magnitude faster than that of oxygen vacancy generation. Hence, CO₂ formation in time-resolved CO oxidation experiments was used to semi-quantitatively measure these short-lived active oxygen species at 300° C. Compared to the Pt/CeO₂ sample, steam treatment doubles the amount of active lattice oxygen in Pt/CeO₂_{_}S (FIG. 3C).

The oxygen species of the catalysts were further characterized by H₂ temperature programmed reduction (H₂-TPR) analysis (FIG. 3D). The reduction of bulk oxygen on CeO₂ takes place at or above 600° C. and the absence of reduction peak below room temperature was confirmed by cryo H₂-TPR. Two major reduction peaks were observed for Pt/CeO₂ sample: 1) reduction of the surface lattice oxygen in vicinity of Pt (Pt—O—Ce bond), centered at 184° C.; 2) reduction of surface lattice oxygen on CeO₂ distant from Pt, centered at 348° C. Over Pt/CeO₂_{_}S, an second reduction peak at 162° C. was observed, which is likely due to a new type of active surface lattice oxygen generated during steam treatment. It is possible that over Pt/CeO₂_{_}S, CO adsorbed on Pt sites can be readily oxidized by this type of active surface lattice oxygen as confirmed by DRIFTS (FIG. 3B) while over Pt/CeO₂ it cannot (FIG. 3A). Detailed quantitative analysis for H₂-TPR suggests that some of the surface oxygen on CeO₂ close to platinum was also reduced by H₂ below 200° C. in addition to the Pt—O—Ce bonds (and/or the activated surface lattice oxygen).

It has been accepted that the CO oxidation reaction over metallic platinum supported on non-reducible oxides (Al₂O₃, SiO₂ etc.) follows a Langmuir-Hinshelwood mechanism. For example, over Pt/Al₂O₃, CO has an inhibiting effect on Pt⁰ reactivity at low temperatures due to competitive adsorption between CO and O₂, with a kinetic rate expression of r=k·P_{CO}⁻¹·P_{O2}¹. In contrast, over Pt/CeO₂ catalysts, a Mars-van Krevelen reaction mechanism is followed with oxygen adsorption and activation preferentially occurring on ceria (in vicinity of Pt) and its competitive adsorption with CO over the metal sites being circumvented. Since both Pt/CeO₂ and Pt/CeO₂_{_}S have similar atomically dispersed Pt in the form of Pt²⁺, the active surface lattice oxygen aforementioned should be responsible for the differences in the low-temperature reactivity of these two catalysts. In the current study, Pt/CeO₂ sample (aged in air at 800° C.) did not show CO oxidation activity at temperatures lower than 210° C. (FIG. 2C). It was reported that thermal aging at 800° C. leads to strong Pt—O—Ce bond formation, which over-stabilizes the surface lattice oxygen and results in the lack of low-temperature CO oxidation reactivity. On the other hand, the strong Pt—O—Ce bond leads to atomically dispersed Pt and excellent thermal stability (without Pt sintering or CeO₂ structure collapse). In the case of Pt/CeO₂_{_}S, the Pt—O—Ce bond is retained even after harsh steam treatment (i.e. Pt remained as atomically dispersed), and also evidenced by the XPS and Raman spectra. Therefore, compared to Pt/CeO₂, the improvement in low-temperature CO oxidation reactivity of Pt/CeO₂_{_}S can be attributed to the effect of high temperature steam treatment (H₂O vapor) whose role is complex and being actively investigated.

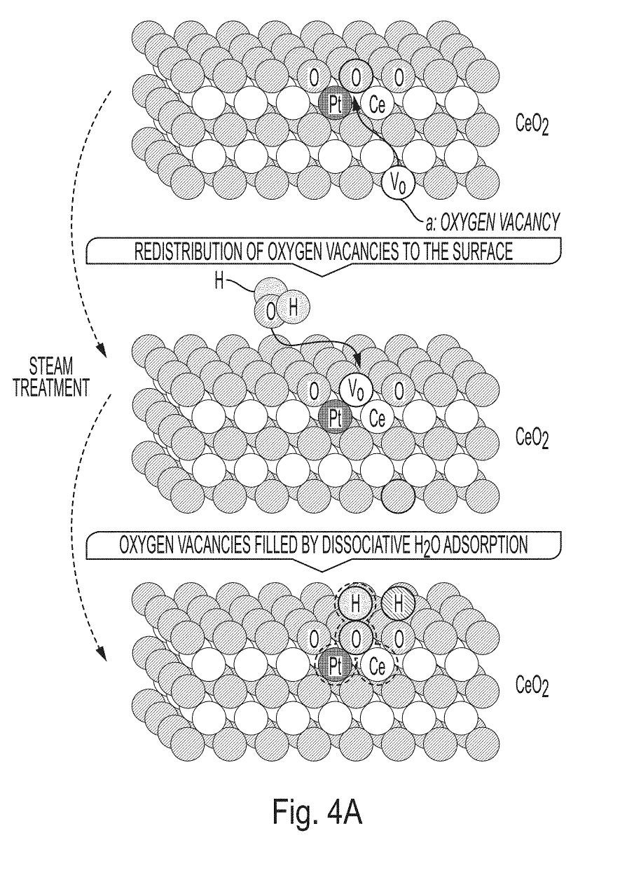

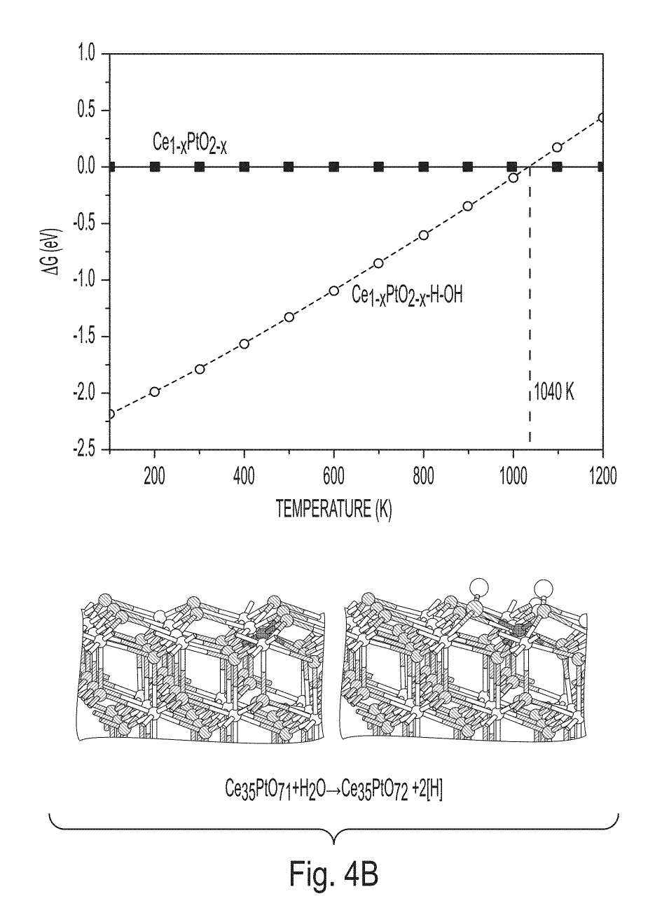

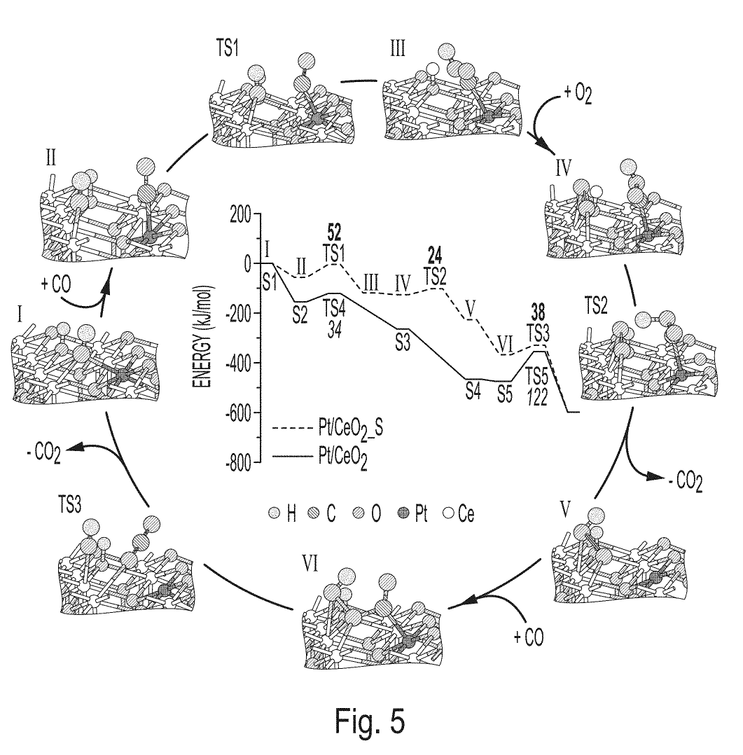

To better understand the nature of this new type of active surface lattice oxygen generated by high temperature steam treatment (H₂O vapor) on Pt₁/CeO₂, DFT calculations and reaction kinetic analysis were conducted. Oxygen vacancies from the CeO₂ bulk can be redistributed to the surface (FIG. 4A) on CeO₂(111) resulted from exposure of water at high temperature of 650 K, as previously reported. Under steam treatment conditions, H₂O molecules could fill out the oxygen vacancy (V_{O}) over Pt₁/CeO₂ surface, generating two neighboring active O_{lattice}[H] in vicinity of Pt (FIG. 4A), which are thermodynamically stable up to 1040 K (767° C.) (FIG. 4B). Accordingly, CO oxidation reaction cycle over this steam treated Pt₁/CeO₂_{_}S is considered. The calculated energy profile is shown in FIG. 5 (inset). The starting configuration only involves one catalytically active O_{lattice}[H] site, coordinated with a Pt atom (Pt²⁺) (FIG. 5, I). The surface O_{lattice}[H] reacts with CO adsorbed on Pt and creates an oxygen vacancy (V_{O}) (FIG. 5, III) with an activation barrier of 52 kJ·mol⁻¹ and exothermicity (□H) of −63 kJ·mol⁻¹. The V_{O} is then filled by adsorption of an oxygen molecule. CO₂ is generated via the deprotonation of the carboxyl intermediate assisted by the newly adsorbed oxygen molecule with the activation barrier of 24 kJ·mol⁻¹ (FIG. 5, TS2). Thereafter, the OO[H] species (FIG. 5, V) reacts with the second adsorbed CO, generating another CO₂ molecule with a smaller activation barrier of 38 kJ·mol⁻¹ (FIG. 5, TS3). Finally, the Pt₁/CeO₂_{_}S surface is recovered after CO₂ desorption and the catalytic cycle over the steam-treated catalyst surface (2O_{lattice}[H]) is closed. The overall energy barrier of the entire reaction cycle is 52 kJ·mol⁻¹, which agrees with the measured apparent activation energy from the Arrhenius plot of 43 kJ·mol⁻¹ for Pt₁/CeO₂_{_}S. For comparison, CO oxidation over Pt/CeO₂ without steam treatment was also calculated (FIG. 5, inset). In this case, the reaction cycle starts with CO reacting with the adsorbed oxygen molecule at the V_{O} site. After CO₂ desorption, the surface V_{O} is filled as the O_{lattice}. Then the O_{lattice} reacts with the second adsorbed CO at the Pt site forming the second CO₂. The overall activation barrier is 122 kJ·mol⁻¹ which, again, agrees with the apparent activation energy of 105 kJ mol⁻¹ for Pt/CeO₂, more than double of that of Pt/CeO₂_{_}S.

The active O_{lattice}[H] site generated from steam treatment is fundamentally different from the previously reported surface hydroxyl on the Ce which is formed over atomically dispersed Pt/CeO₂ by co-feeding water during CO oxidation or water dissociation over Pt/CeO₂. Co-feeding water in the reactants can further enhance the low-temperature CO oxidation activity over Pt/CeO₂_{_}S. However, such enhancement disappears when water in the feedstock was discontinued, due to the instability of the hydroxyls formed on the Ce under reaction conditions. In contrast, here the active O_{lattice}[H] generated via high temperature steam treatment is thermally much more stable (up to 767° C.), and below this temperature, it can be readily regenerated during CO oxidation reaction cycles without the need of co-feeding water. This is the main reason that we observed no deactivation during light off measurements up to 500° C. and only at 800° C. did we see slight deactivation of the catalyst. The stronger basicity of the O_{lattice}[H] compared to surface hydroxyl may also lead to the optimal Lewis-base acidic pairs that promote low temperature CO oxidation.

Well-defined atomically dispersed ionic Pt/CeO₂, as prepared by calcination in air, does not provide low-temperature CO oxidation reactivity. Harsh steam treatment at high temperature dramatically enhances the low-temperature reactivity, while Pt still remains atomically dispersed. Such dramatic enhancement of low-temperature reactivity is attributed to the migration of oxygen vacancies to the surface of CeO₂ in vicinity of Pt by steam treatment (FIG. 4A). The formed surface oxygen vacancies are then refilled by H₂O, leaving active O_{lattice}[H] over the surface (H₂O+V_{O}↔2O_{lattice}[H], V_{O}: oxygen vacancy). These active O_{lattice}[H] sites are stable at high temperatures and drastically reduce the overall activation barrier. In other words, the steam treatment activates the surface lattice oxygen of the CeO₂ support and enables it to participate in low-temperature CO oxidation. At the same time, the catalyst is immune from deactivation caused by oxidation under lean burn conditions, since the Pt is already in oxidized form and anchored to the support thus does not sinter. Since water vapor is always present in vehicle exhaust, our catalyst is inherently stable under these conditions since it was synthesized via calcination at 800° C. in air followed by steam treatment at 750° C. More importantly, this enhanced CO oxidation is found to occur also on other commercially available ceria, for example from Aldrich and Rhodia. High temperature steam treatment not only enhances the CO oxidation under simulated vehicle exhaust conditions, but also improves the oxidation of other components of exhaust, such as saturated and unsaturated hydrocarbons (propane and propylene) and NOₓ. The enhanced reactivity is not due to the formation of Pt nanoparticles but rather the activation of the ceria support surface oxygen. This demonstration of the hydrothermal stability along with high reactivity, makes it possible to bring single atom catalysis closer to industrial applications.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. A catalyst material comprising platinum atomically dispersed on an activated ceria support and having a T₉₀ value less than or equal to 150° C., wherein the T₉₀ value represents the temperature required for 90% CO conversion.

2. The catalyst material of claim 1, wherein the activated ceria support comprises activated surface lattice oxygen sites.

3. The catalyst material of claim 2, wherein the activated surface lattice oxygen sites are proximal to the atomically dispersed platinum.

4. The catalyst material of claim 2, wherein the activated surface lattice oxygen sites are stable up to 800° C. in an oxidizing environment.

5. The catalyst material of claim 1, exhibiting a second reduction peak at temperature lower than a first reduction peak attributed to a Pt—O—Ce bond in a hydrogen temperature programmed reduction profile.

6. The catalyst material of claim 1, having no observable aggregates of platinum at the surface region of the catalyst material.

7. The catalyst material of claim 1, capable of maintaining 95% CO conversion for at least 300 hours at 145° C. for an exhaust stream having a gas hourly space velocity of 200,000 ml per gram of the catalyst material and a CO/O₂ molar ratio of 1/25.

8. The catalyst material of claim 1, wherein the atomically dispersed platinum is covalently bonded to the activated ceria support.

9. The catalyst material of claim 1, further comprising Pt²⁺ atomically dispersed on the activated ceria support.

10. A method comprising hydrothermally treating at a temperature of at least 700° C. a Pt/ceria material comprising atomically dispersed Pt on a ceria support and activating 90% CO conversion at a temperature less than or equal to 150° C. (i.e., T₉₀≤150° C.).

11. The method of claim 10, further comprising forming active surface lattice oxygen sites on the ceria support.

12. The method of claim 11, wherein the active surface lattice oxygen sites are in the vicinity of Pt atoms.

13. The method of claim 11, further comprising calcining in an oxidizing environment the Pt/ceria material at a temperature greater than or equal to 650° C. prior to said hydrothermally treating step.

14. The method of claim 13, wherein said calcining occurs at a temperature greater than or equal to 800° C.

15. The method of claim 10, wherein the Pt/ceria material comprises a non-zero amount of Pt that is less than or equal to 3 wt %.

16. The method of claim 10, wherein said hydrothermally treating comprises heating the Pt/ceria material in an environment having a non-zero amount of water.

17. The method of claim 16, wherein the non-zero amount of water is less than 15%.

18. The method of claim 10, further comprising maintaining atomic dispersion of the Pt on the ceria support.

19. A vehicle catalytic converter comprising a catalyst material on a monolith, the catalyst material comprising platinum atomically dispersed on an activated ceria support and having a T₉₀ value less than or equal to 150° C., wherein the T₉₀ value represents the temperature required for 90% CO conversion.

20. The vehicle catalytic converter of claim 19, wherein the activated ceria support comprises activated surface lattice oxygen sites proximal to the atomically dispersed platinum.
